(19) United States
(12) Patent Application Publication
(10) Pub. No.: US 2009/0294704 A1
(43) Pub. Date: Dec. 3, 2009

(54) Active millimeter wave imaging system and method

(76) Inventors: Eitan Zailer, Haifa (IL); Zvi Zlotnick, Haifa (IL); Leslie Salem, Haifa (IL); Shimon Peled, Haim (IL)

Correspondence Address: Pearl Cohen Zedek Latzer, LLP, 1500 Broadway, 12th Floor, New York, NY, 10036, US

(21) Appl. No.: 11/921,648

(22) PCT Filed: Jun. 5, 2006
(86) PCT No.: PCT/IL2006/000651

§ 371 Date: Jul. 6, 2009

Related U.S. Application Data
(60) Provisional application No. 60/688,337, filed on Jun. 8, 2005.

(51) Int. Cl. G03C 5/16

(52) U.S. Cl. 250/580

(57) ABSTRACT

A system and method for millimeter wave imaging, comprises at least one illumination source (10) of a millimeter wave beam; a diffuser array (12) comprising a plurality of diffuser elements (12) for diffusing the beam from the illumination source (12) across the desired sector; and at least one camera (16) for obtaining an image of one or more illuminated subjects within the desired sector.

### FIELD OF THE INVENTION

The present invention relates to imaging and specifically to a wide angle active millimeter wave imaging system and method.

### BACKGROUND OF THE INVENTION

The high transparency of most clothing material to electromagnetic radiation at millimeter wavelengths has lent a strong motivation to the development of imaging systems capable of detecting concealed objects on a human carrier. Passive millimeter imaging systems rely mostly on the differences in material reflectance and the large brightness temperature variation with zenith angle that exists naturally outdoors to produce images with reasonable object detail.

WO 2005/062943 (Louberg et al.) discloses a passive millimeter wave imaging system that includes at least one millimeter wave frequency scanning antenna and multiple beam formers collecting narrow beams of millimeter wave radiation from a two-dimensional field of view. See also US 2005116947, WO 2005/017559, US 2004056790.

While outdoor passive MMW imaging is fairly effective, under indoor conditions the brightness temperature distribution of the surroundings is vastly reduced and is typically of the order of 0-20 K. Under these conditions the performance of passive millimeter cameras with regards to the detection of concealed objects is greatly reduced.

In US 20060017605 a millimeter wave portal imaging system for the detection of concealed weapons, explosives and other contraband items was disclosed. The millimeter wave imaging system described includes a number (such as 64) of millimeter wave detection units each including a frequency scanning antenna and associated electronics. The units are mounted in four posts (16 per post) of a portal structure. Each unit collects frequency dependent beams of millimeter wave radiation from a narrow field of view. A two dimensional image of a portion of a person passing through the portal is obtained by moving the person (or having the person move) across the field of view of each of the frequency scanning antennas. The images from the antennas can be monitored separately or data from the antennas can be combined with a computer processor to form images of the person. It is evident that this solution is limited to a very small space, and renders security scanning of subjects slow and cumbersome.

In order to enhance detection under indoor conditions an active millimeter wave imaging system is needed.

U.S. Pat. No. 6,992,616 (Grudkowski et al.) discloses an active millimeter wave imaging system, where an antenna apparatus is configured to transmit toward and receive from a subject in a subject position, electromagnetic radiation. See also US 2006012510, US 2005122257, US 2005122249, US 2005231416 (all to Safeview Inc.). These MMw imaging systems generally work in a narrow field of view.

Objects that have a smooth surface reflect electromagnetic waves incident on them specularly. This means that for object sizes large compared to the wavelength of the incident radiation, the reflected wave is directional and the reflected intensity in the specular direction is obtained from the Fresnel relations. When the object sizes are comparable or smaller than the wavelength then one has to account also for diffraction effects. The wavelength of the incident wave also serves as a scale of smoothness of the surface from which it is reflected or scattered.

Assuming that the human skin also reflects millimeter wave radiation in a specular manner a remote imaging system has to cope with the very directional nature of the reflected radiation from the human body. The implication of imaging a specularly reflecting surface is that only certain portions of the object surface that are oriented favorably will appear in the image. Hence in order to image a specular object one has to provide illumination that covers a wide angle such that all parts of the object surface will be imaged.

A preferred mode of illumination would be one which realizes a total hemispherical source with the illuminated object located at the centre of the hemisphere, but the present invention is not limited to hemispherical configuration. By placing a source (or several sources for more illumination power) inside a volume surrounded by diffuse reflector elements and thereby realizing integrating spherical geometry one can achieve omnidirectional illumination. Another way to obtain omnidirectional illumination would be by raising the temperature of the surrounding surfaces and thereby utilizing the self emitted radiation as the source of illumination. The main drawback with these methods is their practical realization in an open environment.

US 2005/0110672 (Cardiasmenos et al.) disclosed an inspection system that can detect contraband items concealed on, in or beneath an individual's clothing. The system employs MMW radiation to detect contraband items. The system is described in connection with a check point security system that includes temperature controlled walls which dissipate spatial MMW radiation to enhance imaging of contraband items. Also, a MMW camera is used in conjunction with a camera that forms visible images.

In U.S. Pat. No. 5,073,782 (Huguenin et al.) a contraband detection system for detecting concealed non-metallic contraband carried by a person is disclosed. Plural sources (located on either side of the camera) of quasi-coherent millimeter wave radiation are disposed so as to uniformly illuminate a field of view. In the preferred embodiment, the radiation emitted by the sources is linearly polarized in a single plane such that the polarization of the radiation with respect to the plane in which linearly polarized radiation is preferentially received by the detectors can be controlled. For detection of dielectric objects, such as ceramic weapons or narcotics, these planes of polarization should be orthogonal to one another. The detector is a two dimensional staring array and the signal provided by each element of the detector array corresponds to the illumination reflected from objects in a single portion of the field of view. Real-time imaging of concealed dielectric and metallic objects is thus made possible.

The present invention is aimed at providing a millimeter wave imaging system that uses an illumination source (coherent or quasi-coherent) that generates an illuminating beam which is dispersed peripherally so as to illuminate the inspected subject from several sides (effectively acting as several sources of illumination)/

Other advantages and properties of the present invention will become apparent after reading the present specification and considering the accompanying figures.

### SUMMARY OF THE INVENTION

There is thus provided, in accordance with some preferred embodiments of the present invention, a system for millimeter wave imaging, the system comprising:

at least one illumination source of millimeter wave beam;

a diffuser array comprising a plurality of diffusive elements for diffusing the beam from the illumination source across a desired sector; and

at least one camera responsive to millimeter wave radiation for obtaining an image of one or more illuminated subjects within the desired sector.

Furthermore, in accordance with some preferred embodiments of the present invention, each of the diffusive elements comprises a reflection phase grating element.

Furthermore, in accordance with some preferred embodiments of the present invention, the reflection phase grating element comprises a grating element which diffracts the incident waves into the same number of directions as the number of stacks in one period.

Furthermore, in accordance with some preferred embodiments of the present invention, the reflection phase grating element comprises a grooved metallic surface of predetermined groove depth, spacing between adjacent grooves and grating period.

Furthermore, in accordance with some preferred embodiments of the present invention, each of the diffusive elements comprises a cap-shaped diffusive element.

Furthermore, in accordance with some preferred embodiments of the present invention, each of the diffusive elements comprises a pyramid-shaped diffusive element.

Furthermore, in accordance with some preferred embodiments of the present invention, the diffuser array comprises an array of amorphous diffusive elements.

Furthermore, in accordance with some preferred embodiments of the present invention, the illumination source comprises a millimeter wave beam generator for generating millimeter waves of wavelengths in a range between 1 to 10 millimeters.

Furthermore, in accordance with some preferred embodiments of the present invention, the illumination source comprises a wave beam generator for generating millimeter waves of frequencies in a range between 75 to 110 GHz.

Furthermore, in accordance with some preferred embodiments of the present invention, the system is further provided with a corridor through which said one or more illuminated subjects are led so as to allow acquiring one or more images of the subjects by said at least one camera.

Furthermore, in accordance with some preferred embodiments of the present invention, the corridor is provided with at least one mirror surface for reflecting diffused millimeter wave illumination on the subject.

Furthermore, in accordance with some preferred embodiments of the present invention, said at least one mirror surface comprises two mirror surfaces positioned substantially opposing each other, on either sides of the corridor.

Furthermore, in accordance with some preferred embodiments of the present invention, said at least one mirror surface, comprises a floor surface.

Furthermore, in accordance with some preferred embodiments of the present invention, the corridor is provided with an entrance gate and an exit gate.

Furthermore, in accordance with some preferred embodiments of the present invention, the exit gate is across the corridor from the entrance gate, and wherein said at least one camera comprises two cameras positioned at substantially opposing sides of the corridor.

Furthermore, in accordance with some preferred embodiments of the present invention, said at least one camera comprises a single camera positioned at one end of the corridor, wherein the entrance gate and the exit gate are located substantially at one side of the corridor, and wherein a partition is provided in the corridor to force the subjects to follow a to and fro pass with respect to the camera to allow the camera to acquire frontal and back images of said one or more illuminated subjects.

Furthermore, in accordance with some preferred embodiments of the present invention, said at least one camera is provided with at least one polarizer.

Furthermore, in accordance with some preferred embodiments of the present invention, the system is further provided with at least one imaging device in the visible range.

Furthermore, in accordance with some preferred embodiments of the present invention, said at least one imaging device in the imaging range is bore-sighted with said at least one camera.

Furthermore, in accordance with some preferred embodiments of the present invention, there is provided a method for millimeter wave imaging, the method comprising:

using at least one illumination source, generating a millimeter wave beam;

illuminating a desired sector by diffusing the beam by a diffuser array comprising a plurality of diffusive elements; and

obtaining at least one image of one or more subjects illuminated by the diffuser array within the desired sector, using at least one camera responsive to millimeter wave radiation.

Furthermore, in accordance with some preferred embodiments of the present invention, the millimeter wave beam is characterized as having a multitude of polarizations and wherein obtaining said at least one image comprises obtaining at least two images acquired under orthogonal polarization conditions, using at least one polarizer with said at least one camera.

Furthermore, in accordance with some preferred embodiments of the present invention, the method further comprises constructing an image that is a summation of said at least two images acquired under orthogonal polarization conditions.

Furthermore, in accordance with some preferred embodiments of the present invention, the method further comprises constructing an image that is a subtraction of said at least two images acquired under orthogonal polarization conditions.

Furthermore, in accordance with some preferred embodiments of the present invention, the method further comprises constructing an image that is a quotient of a subtraction and a summation of said at least two images acquired under orthogonal polarization conditions to obtain a degree of polarization image.

Furthermore, in accordance with some preferred embodiments of the present invention, said at least one image is obtained under different polarization conditions.

Furthermore, in accordance with some preferred embodiments of the present invention, said at least one image is normalized with illumination irradiance of the sector to obtain a reflectance coefficient map.

Furthermore, in accordance with some preferred embodiments of the present invention, the method further comprises providing at least one mirror surface for directing diffused millimeter wave illumination onto said one or more subjects.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a millimeter wave imaging system according to a preferred embodiment of the present invention.

FIG. 2 illustrates a method for detecting various concealed materials using an active millimeter wave imaging system, which uses spatial illumination, such as the one shown in FIG. 1.

FIG. 3 illustrates an array of cap-shaped diffusers incorporated in a wall according to a preferred embodiment of the present invention, concealed beneath a cover layer.

FIG. 4 illustrates an array of pyramid-shaped diffusers incorporated in a wall according to another preferred embodiment of the present invention, concealed beneath a cover layer.

FIG. 5a illustrates detail of an array of cap-shaped diffusers, according to a preferred embodiment of the present invention.

FIG. 5b illustrates detail of an array of pyramid-shaped diffusers, according to a preferred embodiment of the present invention.

FIG. 5c illustrates detail of an amorphous array of diffusers according to a preferred embodiment of the present invention.

FIG. 6 illustrates an indoor inspection corridor, where the inspected subjects follow a to and fro path with respect to a single MMW camera, according to a preferred embodiment of the present invention.

FIG. 7 illustrates an indoor inspection corridor, where the inspected subjects follow a one-way path, while being imaged from opposing sides by two MMW cameras, according to another preferred embodiment of the present invention.

FIG. 8 illustrates a proposed set up for an inspection corridor according to a preferred embodiment of the present invention.

### DETAILED DESCRIPTION OF PREFERRED EMBODIMENTS

The inventors of the present invention have invented an Active MMW Imaging System (hereinafter—AMMIS) that is based on one or more millimeter wave sources, an array of specially designed diffusers for dispersing millimeter wave radiation over an inspected sector and one or more passive millimeter wave cameras that enable rapid and reliable screening of human (or other) subjects to detect the presence of contraband or concealed weapons.

A wide-angle illumination can be achieved by spatially distributing a number of point sources (as in U.S. Pat. No. 5,073,782) or by achieving a diffuser type surface source that distributes energy over a wide angular region. Another way to obtain omnidirectional illumination is with a reflection grating type of surface that redistributes the incident beam over several narrow beams that are displaced angularly and thereby illuminate the object surface from different directions.

The present invention deals with a millimeter wave diffusing system that is based on reflection grating elements or other diffusive elements that are used to achieve omnidirectional illumination over a spatial region in indoor surroundings.

The present invention deals with the realization of an omnidirectional millimeter wave illumination system based on a millimeter wave source and an array of diffusive elements (for example, several reflection grating plates and other diffusive elements—see further explanation and accompanying drawings) that are suitably positioned around the sector to be inspected in order to achieve omnidirectional illumination over that given sector.

The AMMIS offers the ability to utilize both intensities and polarization information of the investigated scene for material discrimination.

In an alternative method of discriminating between various materials images of the inspected scene are acquired under different polarization conditions and analyzed.

In another alternative method of discriminating between various materials the special illuminating system disclosed herein offers the possibility of converting the radiometric image obtained by the camera to a reflectance coefficient image (following suitable calibration), which is in fact a reflectance map of the investigated scene.

According to a preferred embodiment of the present invention, the system method of illumination is designed to achieve omnidirectional illumination over an open space region using grating plates as diffusers and a standard oscillator source (or sources as required).

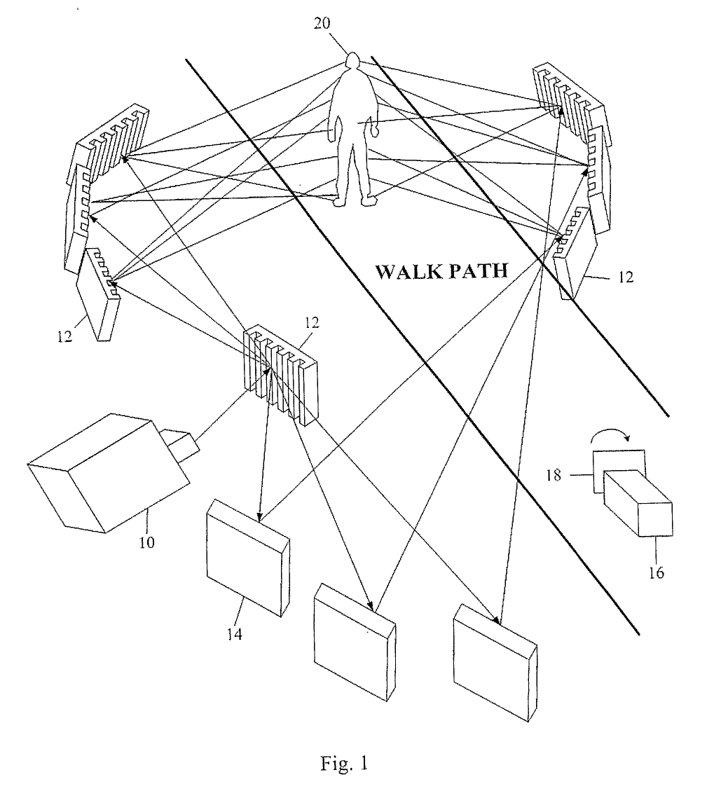

A millimeter wave source is a commercially available item and provides a single narrow beam of millimeter wave radiation. This single beam is directed onto a reflection grating plate that is designed to split the single incident beam to a multiple number of beams of equal intensity that cover well defined angular slices over an azimuthal coverage of 180 degrees (or other desired coverage). A subsequent reflection grating plate positioned to receive one of the previously diffracted beams will in turn produce a fan of beams and so on. Thus from a single beam source one achieves an omnidirectional coverage of illuminating beams over an open unconfined region of space. Taking into account a millimeter wave camera with a typical temperature resolution of 1K we estimate an open path illuminated region about 5 m in width and 5 m in length as shown in FIG. 1.

FIG. 1 illustrates a millimeter wave imaging system, in accordance with a preferred embodiment of the present invention.

FIG. 1 schematically presents the novel illumination concept. The main types of components of the illumination system are designated as follows. The diffuser plates are designated numeral 12; the mirror elements are numbered 14 and the millimeter wave source is numbered as 10. A millimeter wave source 10 emits a single beam that is incident on a diffuser plate 12, from which multiple beams are diffracted to either side of the first diffuser plate. At least some of the beams are directed onto additional diffuser plates 12 giving rise to more diffracted beams as shown. These beams are utilized for illuminating the human object (note that the present invention is not limited to screening human subjects only) from one side of the “walk path” shown in the figure. The second set of beams from the first diffuser plate is directed towards another set of diffuser plates 12 via mirrors 14. The beams diffracted from the mirrors serve to illuminate the human object from the other side of the “walk path”. A camera type receiver 16 responsive in the MMW range is positioned further up the “walk path” to record images as the human object walks past the illuminated zone. The MMW camera may be also bore-sighted with a visible camera covering the same field of view as the MMW camera. An imaging system according to a preferred embodiment of the present invention can also involve using a supplementary imaging sensor in the visible range, that can be used to acquire additional information or that can be used for cross referencing between relevant MMW information and visible range information. This can be implemented, for example, by indicating on the image obtained in the visible range locations of suspected regions that were obtained from the MMW image.

The diffuser grating element 12 is typically a reflection phase grating element which diffracts the incident waves into the same number of directions as the number of stacks in one period. The amplitude of the diffracted waves can be modified by choosing the different stack heights in a proper manner. According to Fourier optics the far field of a grating is the Fourier transform of the complex amplitude of the electro-magnetic wave as a function of position as it leaves the grating. Thus if one wants a broad diffraction pattern one must have distributions that have a broad Fourier spectrum. In order to obtain waves of uniform magnitude upon leaving the grating, the distribution should be a function of constant magnitude that has a broad Fourier spectrum. One answer to this problem is provided by maximum length sequences known from the pseudorandom noise theory. These periodic sequences of period length L=(2^{m}−1)*w, where “w” is the grating constant, have the property that their power spectrum is completely flat.

The grating element is realized by constructing a grooved metallic surface where the depth of the grooves, the spacing between adjacent grooves and the number of grooves in a grating period are design parameters. Based on these parameters the angular directions of the scattered beams can be calculated and hence are well-defined. The finite width of the grating causes the discrete scattering angles to become finite width lobes. By contrast a plain piece of metal would exhibit only one narrow lobe.

As an example consider the design of a diffuser element that gives a total of 6 discrete beams of the same strength. The basic period of the grating would consist of 6 stacks or grooves of different depths. The stacks are spaced at a distance of λ/2 from each other and the stack heights would be in the order 3, 2, 6, 4, 5, 1 where the heights are in units of λ/2. where λ is the radiation wavelength. A diffuser surface of this period would split an incident beam to 6 discrete beams whose angular directions are determined to be at ±19°, ±42°, ±90°.

The source of radiation is a commercially available item and forms an integral part of the illumination system. For instance one can acquire a tunable Gunn oscillator source Model QTM92170W from Quinstar Technology Inc.(USA) that provides millimeter wave radiation over the 75-110 GHz frequency range with an output power of 17 dBm (50 mWatt). That company also provides power amplifiers that may be used to increase the output power to 1 Watt. Since the grating elements are metallic and with high reflectivity the intensity of the individual beams at the area of illumination is mostly determined by the number of scatterings undergone along the way. The strength of the source required thus has to be determined taking into account the scattering losses and the level of sensitivity of the detection system used. The diffuser based illumination system can handle a wide range of source intensities and can be tuned to the requirements of the imaging task at hand.

The illumination system described can be used both in indoor and outdoor environments. One of the main applications of this system is to enhance the capabilities of a millimeter wave imaging system to obtain better images by increasing the contrasts of objects against a human body background. The illumination system will also enable easier detection and differentiation of concealed objects placed on the human body.

The differences in the reflected signal attributed to the differences in reflectance of different materials can be enhanced by the illumination system. By a suitable calibration process including maintaining stable illuminating power, the reflected signals can be converted to material reflectance values. This will then serve as a basis for discriminating between different materials such as metals, plastics, organic materials, explosive materials etc.

The illumination system depolarizes the source radiation and hence a polarizing element in the receiver unit is necessary to add specificity in the discrimination of materials. This will also enhance the capability of discrimination between materials belonging to the same generic family such as plastics, organic materials etc.

A polarizing filter 18 can be used on the camera 16 to allow only light of specific polarization to reach the camera. This filter is preferably an adjustable filter allowing realignment of the polarization orientation of the filter, so as to offer imaging in different polarizations.

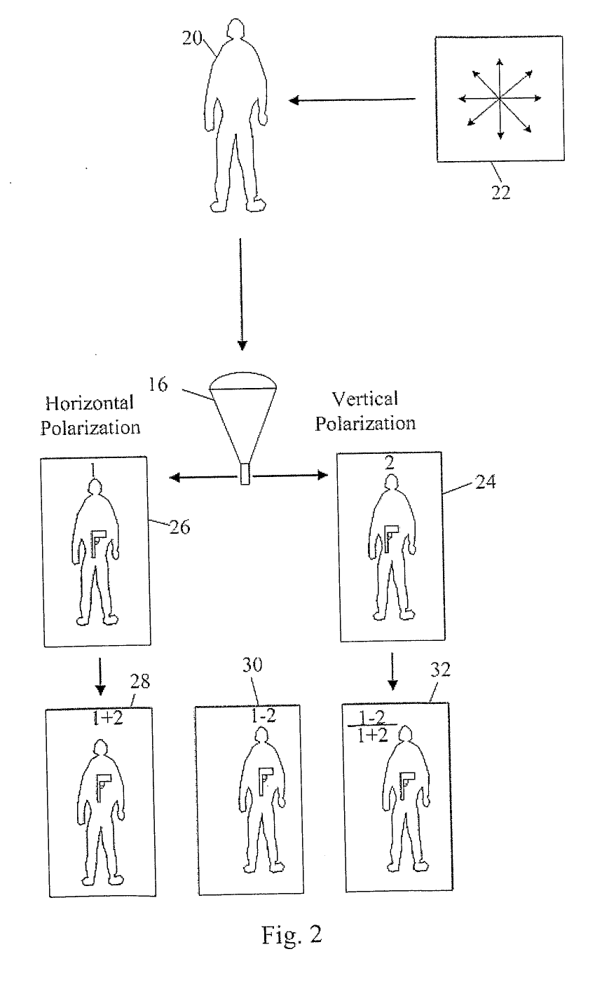

FIG. 2 illustrates a method for detecting various concealed materials using an millimeter wave imaging system, which uses spatial illumination, such as the one shown in FIG. 1. The presence of a concealed gun is not shown on the primary human target 20. Its presence however is shown in the subsequent set of millimeter wave images acquired by a millimeter wave imaging system that casts surrounding illumination of multiple polarizations (22). The camera is made to acquire two images under orthogonal polarizations (such as horizontal and vertical, as indicated in the Figure). The image labeled 1 (26) is a linearly polarized image with polarization orientation in one direction. Similarly the image labeled 2 (24) is a linearly polarized image but with the polarizer in an orthogonal direction.

From these two images three calculated images that are obtained, as follows. The image on the left (28) is a summation of both acquired images, showing the intensity distribution, the image in the middle (30) is a difference image of the two acquired images, and the third image (32) gives a Degree of Polarization image (producing an image that is a calculated image representing the quotient of image 30 and image 28.

Object or material discrimination using the millimeter wave imaging system of the present invention is based on these images. By taking a third image with the linear polarizer oriented at 45 degrees we can also obtain a polarization vector orientation image. (This is not shown in the drawing).

An additional method of discriminating between different materials may be using the calculated reflectance coefficient images of the investigated subjects.

From the raw radiometric image information acquired from a reference surface of known reflectance (for example bare human skin, or other known surfaces present in the investigated scene) the illuminated irradiance is estimated. Based on the estimated irradiance the information from surfaces in the vicinity of the reference surface is converted to corresponding reflectance coefficient values. In other words, the acquired image information is normalized with respect to the irradiance level of illumination on the investigated subject to yield the reflectance coefficient values surfaces on the investigated subject. Thus the raw radiometric image is converted to a reflectance coefficient image with greater specificity for material discrimination purposes.

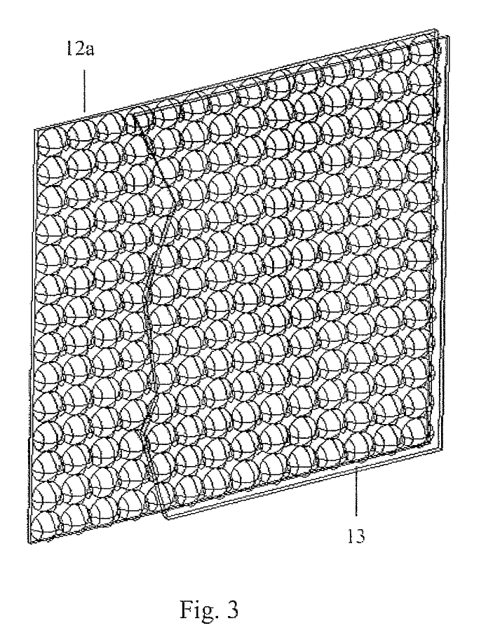

FIG. 3 illustrates an array of cap-shaped diffusers incorporated in a wall according to a preferred embodiment of the present invention, concealed beneath a cover layer 13. The diffusers 12a, here in the form of caps, are distributed discretely, in selected locations, or continuously, all over the wall, concealed behind a cover layer. The cover layer has to be effectively transparent to millimeter wave radiation in order for the diffusers to perform properly. A plaster layer may be suitable for this task.

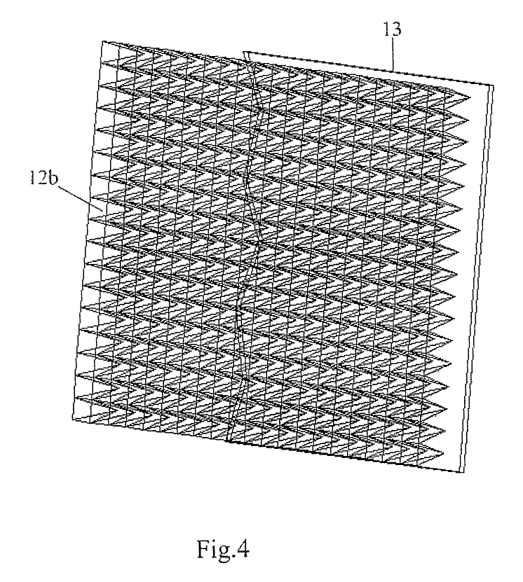

FIG. 4 illustrates an array of pyramid-shaped diffusers 12b incorporated in a wall according to another preferred embodiment of the present invention, concealed beneath a cover layer 13.

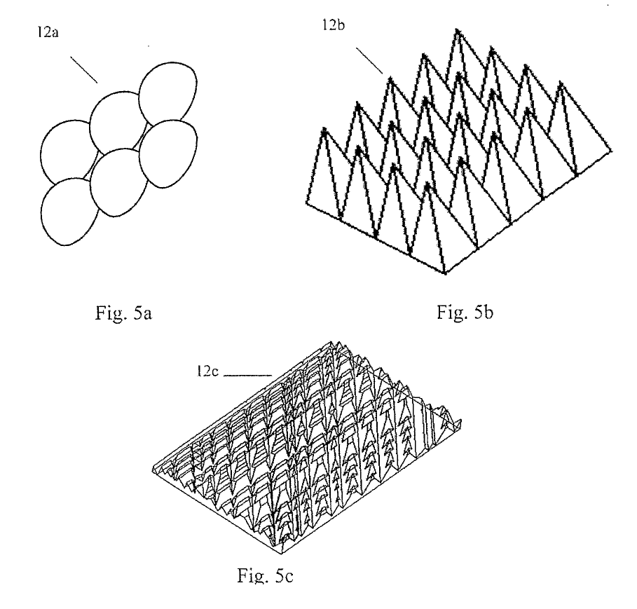

FIG. 5a illustrates detail of an array of cap-shaped diffusers 12a, according to a preferred embodiment of the present invention.

FIG. 5b illustrates detail of an array of pyramid-shaped diffusers 12b, according to a preferred embodiment of the present invention.

FIG. 5c illustrates detail of an amorphous array of diffusers 12c according to a preferred embodiment of the present invention.

The inspection corridor is preferably designed to allow the inspected subjects to pass through it oblivious of the fact that they are being inspected or monitored. This is a real advantage as opposed to inspection portals, which are limited in their inspection capabilities to inspecting one subject at a time, and force the subject to be detained and contained to a small cell throughout the inspection. The method and system of the present invention makes mass screening possible for several reasons. One reason is the fact that a plurality of subjects may be screened simultaneously as the inspected space is relatively large due to the use of artificial illumination obtained through the use of the diffusers. Another reason is the fact that the inspection takes only one or two image to be acquired for a subject as he passes through the inspection corridor, as opposed to obtaining a plurality of images from different narrow fields of view of the subject as demonstrated in prior art applications (see for example patents to Safeview Inc. listed hereinabove).

The walls of the corridor (or other restricting means, such as a rail, partition or similar restrictors) confine the passing subjects to a known path passing the sector illuminated by the diffusers in front of the MMW camera (or cameras).

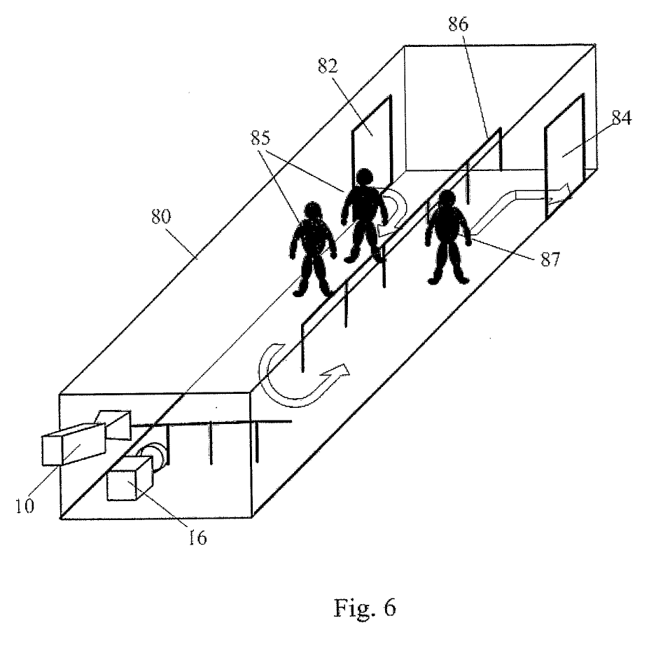

FIG. 6 illustrates an indoor inspection corridor, where the inspected subjects follow a to and fro path with respect to a single MMW camera, according to a preferred embodiment of the present invention. The corridor 80 is provided with an entrance 82 and exit 84 gates. As subjects to be scanned enter through entrance 82 they proceed towards the MMW camera 16 while they are scanned frontally 85 (their images are being taken) and then they turn around and follow the return path towards the exit gate 84 to allow the MMW camera to scan them from the back 87. To force this to and fro path a separating rail or partition 86 is provided along the corridor.

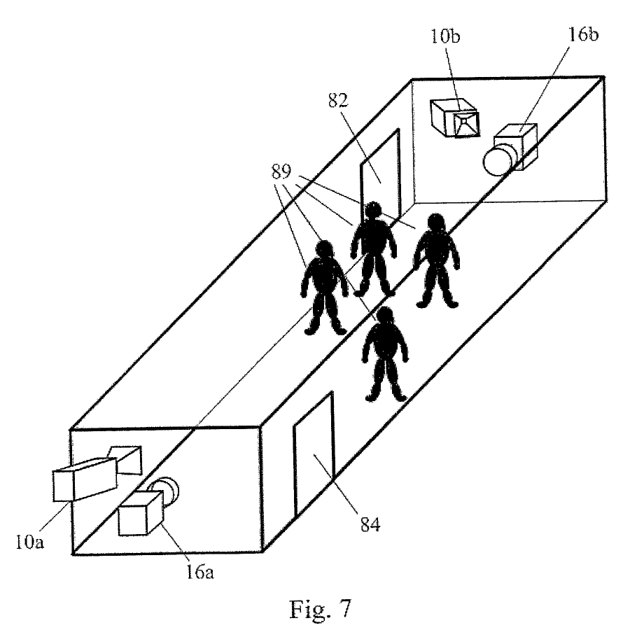

FIG. 7 illustrates an indoor inspection corridor, where the inspected subjects enter through entrance 82, and follow a one-way path towards exit gate 84, while being imaged from two, opposing sides by two MMW cameras 16a and 16b, according to another preferred embodiment of the present invention.

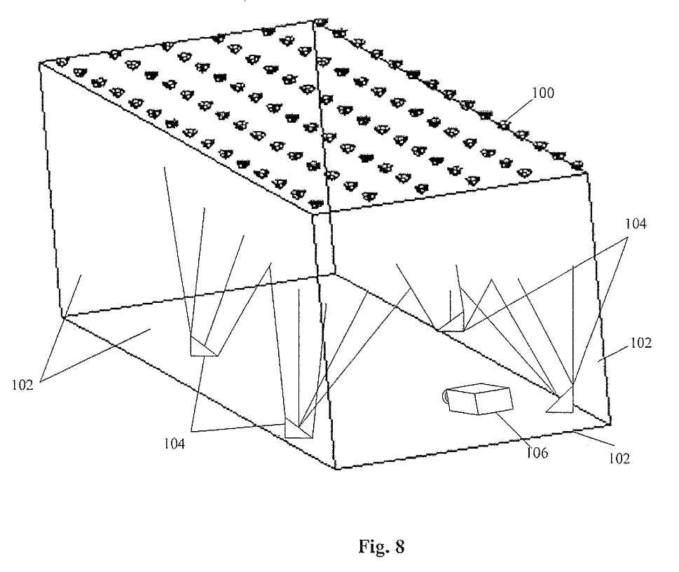

FIG. 8 illustrates a proposed set up for an inspection corridor according to a preferred embodiment of the present invention. Here the corridor is provided with ceiling covered with diffusers 100. The side walls are designed as MMW mirror surfaces (but may also be diffusive surfaces, although using mirror surfaces enhances the illumination on the inspected subjects and offers higher contrast). The floor is provided with a plurality of MMW radiation sources that illuminate the ceiling so that their radiation is diffused by diffusers 100 around the corridor space. MMW camera 106 is positioned on one or more sides of the corridor to scan the passing subjects as they stroll along the corridor (possibly unaware of the fact that they are being scanned and monitored, if the camera and irradiation sources are concealed). The mirror surfaces can be also located on the floor, if the diffuser array is positioned on the roof or on other elevated locations.

An active MMW imaging system according to the present invention offers hidden objects detection, classification and material discrimination at stand-off distances that make this system advantageous for mass screening, and therefore specifically suitable for various homeland security tasks and similar objectives.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1-27. (canceled)

28. A system for millimeter wave imaging, the system comprising:
at least one illumination source of millimeter wave beam;
a diffuser array comprising a plurality of diffusive elements for diffusing the beam from the illumination source across a desired sector; and
at least one camera responsive to millimeter wave radiation for obtaining an image of one or more illuminated subjects within the desired sector.

29. The system of claim 28, wherein each of the diffusive elements comprises a reflection phase grating element.

30. The system of claim 29, wherein the reflection phase grating element comprises a grating element which diffracts the incident waves into the same number of directions as the number of stacks in one period.

31. The system of claim 29, wherein the reflection phase grating element comprises a grooved metallic surface of predetermined groove depth, spacing between adjacent grooves and grating period.

32. The system of claim 28, wherein the diffuser array comprises an array of amorphous diffusive elements.

33. The system of claim 28, wherein the illumination source comprises a millimeter wave beam generator for generating millimeter waves of wavelengths in a range between 1 to 10 millimeters.

34. The system of claim 28, wherein the illumination source comprises a wave beam generator for generating millimeter waves of frequencies in a range between 75 to 110 GHz.

35. The system of claim 28 further provided with a corridor through which said one or more illuminated subjects are led so as to allow acquiring one or more images of the subjects by said at least one camera.

36. The system of claim 35, wherein the corridor is provided with at least one mirror surface for reflecting diffused millimeter wave illumination on the subject.

37. The system of claim 36, wherein said at least one mirror surface comprises two mirror surfaces positioned substantially opposing each other, on either sides of the corridor.

38. The system of claim 36, wherein said at least one mirror surface comprises a floor surface.

39. The system of claim 35, wherein the corridor is provided with an entrance gate and an exit gate.

40. The system of claim 39, wherein the exit gate is across the corridor from the entrance gate, and wherein said at least one camera comprises two cameras positioned at substantially opposing sides of the corridor.

41. The system of claim 39, wherein said at least one camera comprises a single camera positioned at one end of the corridor, wherein the entrance gate and the exit gate are located substantially at one side of the corridor, and wherein a partition is provided in the corridor to force the subjects to follow a to and fro pass with respect to the camera to allow the camera to acquire frontal and back images of said one or more illuminated subjects.

42. The system of claim 28, wherein said at least one camera is provided with at least one polarizer.

43. The system of claim 28 further provided with at least one imaging device in the visible range.

44. The system of claim 43, wherein said at least one imaging device in the imaging range is bore-sighted with said at least one camera.

45. A method for millimeter wave imaging, the method comprising:
using at least one illumination source, generating a millimeter wave beam;
illuminating a desired sector by diffusing the beam by a diffuser array comprising a plurality of diffusive elements; and
obtaining at least one image of one or more subjects illuminated by the diffuser array within the desired sector, using at least one camera responsive to millimeter wave radiation.

46. The method of claim 45, wherein the millimeter wave beam is characterized as having a multitude of polarizations and wherein obtaining said at least one image comprises obtaining at least two images acquired under orthogonal polarization conditions, using at least one polarizer with said at least one camera.

47. The method of claim 46, further comprising constructing an image that is a summation of said at least two images acquired under orthogonal polarization conditions.

48. The method of claim 46, further comprising constructing an image that is a subtraction of said at least two images acquired under orthogonal polarization conditions.

49. The method of claim 46, further comprising constructing an image that is a quotient of a subtraction and a summation of said at least two images acquired under orthogonal polarization conditions to obtain a degree of polarization image.

50. The method of claim 45, wherein said at least one image is obtained under different polarization conditions.

51. The method of claim 45, wherein said at least one image is normalized with illumination irradiance of the sector to obtain a reflectance coefficient map.

52. The method of claim 45 further comprising providing at least one mirror surface for directing diffused millimeter wave illumination onto said one or more subjects.
